(19) United States
(12) Patent Application Publication
(10) Pub. No.: US 2008/0270160 A1
(43) Pub. Date: Oct. 30, 2008

(54) Discriminatory Mileage Offering Method by Load Factor and Computer Readable Record Medium on Which a Program Therefor is Recorded

(76) Inventor: Dae Hee Bang, Seoul (KR)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/814,367

(22) PCT Filed: Jan. 18, 2006
(86) PCT No.: PCT/KR06/00194

§ 371 Date: Oct. 5, 2007

(30) Foreign Application Priority Data
Jan. 21, 2005 (KR) 10-2005-0005708

(51) Int. Cl. G06Q 30/00

(52) U.S. Cl. 705/1

(57) ABSTRACT

The present invention relates to a discriminatory mileage offering method by load factor and a computer readable record medium on which a program therefor is recorded, wherein more mileage is offered when a load factor of an airplane is low while less mileage is offered when the load factor is high, thereby maximizing the satisfaction of airlines and passengers. To this end, the present invention provides a discriminatory mileage offering method, comprising a first step of building a mileage database (DB) using mileage applied discriminatively according to a load factor; a second step of receiving passenger boarding information from a terminal that makes communication connection over an information communication network, and storing and managing the boarding information in a customer information database (DB); a third step of calculating a load factor based on the received boarding information, and retrieving mileage corresponding to the calculated load factor from the mileage database (DB); and a fourth step of extracting a passenger to which the mileage retrieved through the third step is to be offered, offering the mileage to the extracted passenger, and storing and managing the offered mileage and information on the passenger in the customer information database (DB).

### TECHNICAL FIELD

The present invention relates to a discriminatory mileage offering method by load factor and a computer readable record medium on which a program therefor is recorded. More particularly, the present invention relates to a discriminatory mileage offering method by load factor and a computer readable record medium on which a program therefor is recorded, wherein more mileage is offered when a load factor of an airplane is low while less mileage is offered when the load factor is high, thereby maximizing the satisfaction of airlines and passengers and distributing demands concentrated on high-demand seasons and weekends to off-seasons or unpopular time zones.

### BACKGROUND ART

In recent years, mileage services for attraction of members are generally employed as competition becomes severe among airlines. The mileage refers to a kind of reserve that is accumulated according to actual use results of members. The basic unit of the mileage is “miles” of a flight section in which a member was on board.

Each airline offers predetermined mileage for respective flight routes to customers according to customers' actual use results. When the accumulated amount of offered mileage exceeds a predetermined value, a customer can utilize the mileage to purchase an airline ticket or obtain a higher class airline seat. The mileage is offered in proportion to a flight distance of a customer. Usually, mileage offered by an American continent round-trip enables purchase of one Seoul-Jejudo round-trip ticket.

Airlines are burdened with the mileage offered and accumulated according to each route irrespective of a season, a day of the week, a time of the day, and a place. Thus, there is a problem in that concurrent use of accumulated mileage by many customers damages the airlines in business.

Further, in a current inflexible mileage system in which mileage is offered according to a flight distance and mileage that is offered significantly increases at high-demand seasons, there is a problem in that demands concentrated on high-demand seasons and weekends result in a higher load factor but accordingly mileage to be offered increases.

In addition, since predetermined mileage is offered in proportion to flight distances to both customers who contribute to a load factor and customers who do not contribute to a load factor, there are problems in that this reduces the customers' mileage selection ranges and does not contribute to airlines' operating profits.

Accordingly, it is necessary to distribute demands having a higher load factor concentrated on high-demand seasons and weekends to off-seasons and weekdays having a lower load factor.

### DISCLOSURE OF INVENTION

### Technical Problem

The present invention is conceived to solve the aforementioned problems. It is an object of the present invention to maximize the satisfaction of airlines and passengers by discriminatively offering mileage according to a load factor of an airplane.

It is another object of the present invention to distribute demands concentrated on high-demand seasons and weekends and provide airlines' stable operating profits by offering flexible mileage reduced according to an increase in a load factor rather than offering inflexible mileage determined and offered according to a flight distance.

### Technical Solution

According to the present invention for achieving the objects, there is provided a discriminatory mileage offering method comprising a first step of building a mileage database (DB) using mileage applied discriminatively according to a load factor; a second step of receiving passenger boarding information from a terminal that makes communication connection over an information communication network, and storing and managing the boarding information in a customer information database (DB); a third step of calculating a load factor based on the received boarding information, and retrieving mileage corresponding to the calculated load factor from the mileage database (DB); and a fourth step of extracting a passenger to which the mileage retrieved through the third step is to be offered, offering the mileage to the extracted passenger, and storing and managing the offered mileage and information on the passenger in the customer information database (DB).

Preferably, after the fourth step, the method further comprises a fifth step of supporting transmission of a text message indicating the retrieved mileage to a mobile communication terminal of the passenger.

More preferably, the mileage database (DB) stores the mileage therein such that the mileage is reduced as the load factor increases.

Meanwhile, the present invention provides a computer readable record medium on which a program for discriminatively offering mileage by load factor is recorded. The program executes a first process of building a mileage database (DB) using mileage applied discriminatively according to a load factor; a second process of receiving passenger boarding information from a terminal that makes communication connection over an information communication network, and storing and managing the boarding information in a customer information database (DB); a third process of calculating a load factor based on the received boarding information, and retrieving mileage corresponding to the calculated load factor from the mileage database (DB); and a fourth process of extracting a passenger to which the mileage retrieved through the third process is to be offered, offering the mileage to the extracted passenger, and storing and managing the offered mileage and information on the passenger in the customer information database (DB).

Preferably, in the record medium, the program further executes a fifth process of supporting transmission of a text message indicating the retrieved mileage to a mobile communication terminal of the passenger, after the fourth process.

More preferably, in the record medium, the mileage database (DB) stores the mileage therein such that the mileage is reduced as the load factor increases.

### ADVANTAGEOUS EFFECTS

According to the present invention described above, there is an advantage in that the satisfaction of airlines and customers can be maximized by offering mileage depending on a load factor of an airplane, particularly by offering more mileage when the load factor is low and less mileage when the load factor is high.

According to the present invention, there are advantages in that mileage to be offered is decreased at high-demand seasons and demands at off-seasons are continuously increased by offering mileage which is gradually reduced according to an increase in a load factor of an airplane, thereby distributing demands concentrated on high-demand seasons and weekends and providing airlines' stable and efficient business activities and operating profits.

According to the present invention, there is an advantage in that mileage determined by load factor is transmitted to passengers' mobile communication terminals so that the passengers can quickly recognize the mileage.

According to the present invention, there are advantages in that customers can have widened mileage selection ranges and obtain more mileage by making overseas trips, sightseeing or the like at off-seasons.

### BRIEF DESCRIPTION OF THE DRAWINGS

FIG. 1 is a block diagram illustrating an entire configuration of a system for implementing a discriminatory mileage offering method by load factor according to an embodiment of the present invention.

FIG. 2 is a block diagram specifically illustrating a mileage managing server in FIG. 1.

FIG. 3 is a flowchart illustrating a discriminatory mileage offering method by load factor according to an embodiment of the present invention.

FIG. 4 is a graph illustrating an example of discriminatory mileage that is applicable to the present invention.

### EXPLANATION OF REFERENCE NUMERALS FOR DESIGNATING MAIN PORTIONS IN THE DRAWINGS

100: Airline's terminal
150: Mobile communication terminal
200: Information communication network
300: Mileage managing server

### BEST MODE FOR CARRYING OUT THE INVENTION

Preferred embodiments of the present invention will be described in detail with reference to the accompanying drawings.

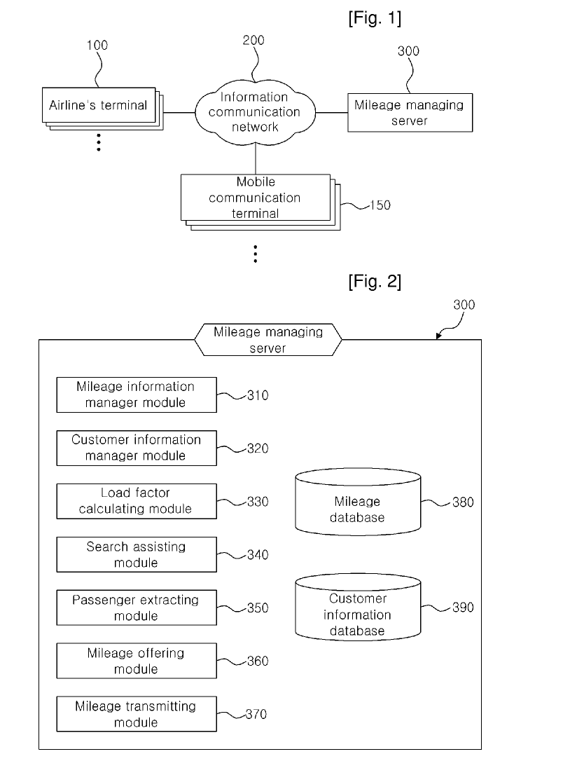

A discriminatory mileage offering method by load factor according to an embodiment of the present invention will be described with reference to FIGS. 1 to 4.

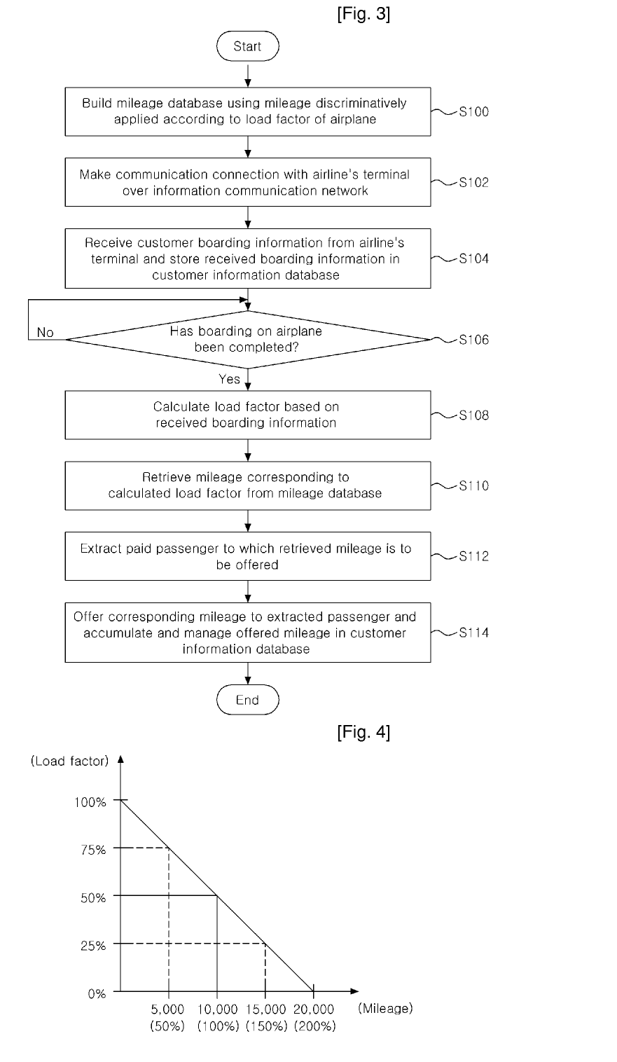

FIG. 1 is a block diagram illustrating an entire configuration of a system for implementing a discriminatory mileage offering method by load factor according to an embodiment of the present invention, FIG. 2 is a block diagram specifically illustrating a mileage managing server in FIG. 1, FIG. 3 is a flowchart illustrating a discriminatory mileage offering method by load factor according to an embodiment of the present invention, and FIG. 4 is a graph illustrating an example of discriminatory mileage that is applicable to the present invention.

FIG. 1 shows a system for implementing a discriminatory mileage offering method by load factor according to an embodiment of the present invention.

As shown in the figure, the system comprises an airline's terminal 100 as an information requester, a mileage managing server 300 as an information provider, a mobile communication terminal 150 for receiving a text message indicating mileage that is determined according to a load factor, and an information communication network 200 for interfacing the airline's terminal 100, the mobile communication terminal 150 and the mileage managing server 300 in a wired/wireless manner.

The airline's terminal 100 is a communicationable computer device. Further, the airline's terminal 100 may include a personal computer such as a desktop computer, a notebook computer, and a workstation computer. Preferably, the personal computer includes at least a Windows 98 or higher operating system, a Pentium-grade or higher CPU, and a 64 Mb or more memory.

The mobile communication terminal 150 is a communicationable device, such as a wireless Internet communicationable mobile phone, a personal digital assistant (PDA) and an IMT2000 terminal.

The information communication network 200 includes an Internet network using a TCP/IP protocol allowing wired connection and a WAP protocol allowing wireless connection, an internal network, and the like. Here, the airline's terminal 100 is connected over the information communication network 200 (e.g., Internet network).

The mileage managing server 300 is a computer system comprising a central processing unit, a random access memory (RAM), a read-only memory (ROM), a network interface, a data storage device, and the like. The mileage managing server 300 may comprise a server computer, such as a personal computer or a workstation having a certain level or higher memory and processing capability.

The mileage managing server 300 stores mileage applied discriminatively according to a load factor in a mileage database (DB) 380, receives boarding information such as a passenger's name, resident registration number, departure place, destination, seat number, flight name and use of a paid/free ticket from the airline's terminal 100 that has made communication connection over the information communication network 200, calculates a load factor based on the received boarding information, and offers mileage corresponding to the calculated load factor to a paid passenger. Preferably, the load factor is calculated just after the airplane departs.

The mileage database (DB) 380 stores mileage to be offered such that it is decreased when the load factor is higher. The passenger boarding information received from the airline's terminal 100 is stored in and managed by a customer information database 390.

Here, a market situation that varies with a season, a day of the week, and a time of the day according to demand and supply, i.e., high-demand season and off-season, weekday and weekend, and day and night is eventually reflected on the load factor.

In this embodiment, the load factor is calculated with substantially paid boarding passengers excluding boarding passengers with free tickets purchased using mileage, airline and travel-agency staffs with 100% discount tickets or special discount tickets, and other passengers with sales promotion tickets provided by the airline. Then, mileage is offered to the paid boarding passengers according to the calculated load factor. That is, even though one hundred airline seats of an airplane are full, if the number of substantial paid passengers is 50, the load factor becomes 50%.

Further, the mileage managing server 300 sends mileage corresponding to the calculated load factor to the mobile communication terminal 150 of a passenger, if necessary. In this case, the mileage managing server 300 transmits a text message indicating the telephone number and the mileage of the passenger to a mobile switching center (not shown) via a base station (not shown). Then, the mobile switching center transmits the text message directed to the telephone number so that the passenger can immediately recognize the offered mileage.

A functional configuration of the aforementioned mileage managing server 300 will be described in detail.

As shown in FIG. 2, the mileage managing server 300 comprises a mileage information manager module 310, a customer information manager module 320, a load factor calculating module 330, a search assisting module 340, a passenger extracting module 350, a mileage offering module 360, a mileage transmitting module 370, the mileage database (DB) 380, and the customer information database (DB) 390.

The mileage information manager module 310 performs correspondence of the mileage applied discriminatively according to a load factor with the load factor and stores and manages the mileage in the mileage database (DB) 380. While this embodiment has been described as offering the mileage, which is reduced as the load factor increases, the present invention includes another point, cybermoney or the like that is reduced as the load factor increases.

Here, the mileage database 380 stores mileage, which is gradually reduced as the load factor increases. For example, the mileage database 380 stores load factors and mileage corresponding to the load factors, i.e., 0, 5000, 10000, 15000, and 20000 mileages respectively corresponding to the load factors of 100, 75, 50, 25 and 0%.

The customer information manager module 320 receives boarding information, which includes information indicating whether a passenger uses a paid or free ticket, from the airline's terminal 100 making communication connection over the information communication network 200, and stores and manages the received boarding information in the customer information database (DB) 390. At this time, the reason why the information on whether a passenger uses a paid or free ticket is received is to offer mileage only to a boarding passenger with a paid ticket according to a load factor without offering mileage to a boarding passenger with a free ticket.

Further, when the accumulated mileage of a customer stored in the customer information database (DB) 390 exceeds a predetermined value, the customer information manager module 320 supports the customer to purchase an airline ticket using the accumulated mileage in response to a user's request. The accumulated mileage becomes a payment means for purchasing an airline ticket.

Further, the customer information manager module 320 may receive member subscription information (e.g., name, address, resident registration number, telephone number, e-mail address, field of interest, desired trip destination, and particulars) through a member subscription webpage transmitted in response to a member subscription request from a user's terminal (not shown) making communication connection over the information communication network 200, and may store and manage the received member subscription information in the customer information database (DB) 390. Accordingly, in response to a request for inquiring mileage by a user who has subscribed as a member, the customer information manager module 320 inquires mileage stored in the customer information database (DB) 390 and provides inquiry results to the user.

The load factor calculating module 330 calculates a load factor based on the passenger boarding information received via the customer information manager module 320 after boarding is completed.

The search assisting module 340 retrieves mileage corresponding to the load factor calculated by the load factor calculating module 330, from the mileage database (DB) 380.

The passenger extracting module 350 extracts a paid passenger to which the mileage retrieved by the search assisting module 340 is to be offered, from the customer information database (DB) 390, and provides information on the extracted paid passenger.

The mileage offering module 360 offers the mileage only to the paid passenger that is extracted by the passenger extracting module 350. The offered mileage is accumulated and managed together with the passenger information in the customer information database (DB) 390.

The mileage transmitting module 370 transmits a text message indicating the retrieved mileage to the mobile communication terminal 150 of the paid passenger so that the passenger can easily recognize the mileage.

If the customer information contains an e-mail address of the paid passenger, the mileage transmitting module 370 also transmits a message indicating the mileage to the e-mail address.

Now, a discriminatory mileage offering method by load factor according to an embodiment of the present invention will be described with reference to FIG. 3.

As illustrated in FIG. 3, the mileage managing server 300 builds the mileage database (DB) 380 using mileage discriminatively applied according to a load factor of an airplane (S100). A market situation that varies with a season, a day of week and a time of day according to high-demand season and off-season, weekday and weekend, and day and night is reflected on the load factor.

The mileage managing server 300 makes communication connection with the airline's terminal 100, which intends to use this service, over the information communication network 200 (S102). In this embodiment, the airline's terminal 100 means a terminal installed at each airline.

The mileage managing server 300 receives boarding information, which contains information indicating whether a passenger uses a paid or free ticket, from the airline's terminal 100 making the communication connection with the mileage managing server 300 over the information communication network 200, and then stores and manages the received boarding information in the customer information database (DB) 390 (S104). When boarding is completed, the mileage managing server 300 receives, from the airline's terminal 100, a message indicating that airplane boarding is completed, and reflects the fact on a subsequent process.

The mileage managing server 300 then determines whether airplane boarding is completed (S106). If it is determined in step S106 that airplane boarding is not completed, the mileage managing server 300 remains in a standby state during a predetermined period of time.

If it is determined in step S106 that airplane boarding is completed, the mileage managing server 300 calculates a load factor based on the passenger boarding information which has been received from the airline's terminal 100 (S108).

The mileage managing server 300 then retrieves mileage corresponding to the calculated load factor from the mileage database (DB) 380 (S110). More mileage is retrieved when the load factor is low, and less mileage is retrieved when the load factor is high.

As can be seen from the graph of FIG. 4, 0, 5000, 10000, 15000, and 20000 mileages are offered when the load factor is 100, 75, 50, 25 and 0%, respectively. Thus, demands concentrated on high-demand seasons and weekends can be distributed. That is, less mileage is offered at high-demand seasons and weekends since the load factor is high, and more mileage is offered at off-seasons or weekdays since the load factor is low. Accordingly, demands at high-demand seasons and weekends can be distributed to off seasons.

The mileage managing server 300 then extracts a paid passenger to which the mileage retrieved from the mileage database (DB) 380 corresponding to the load factor is to be offered, from the customer information database (DB) 390 (S112). Through such an extracting process, a customer who contributes to the load factor and a customer who does not contribute thereto are discriminated.

The mileage managing server 300 then offers corresponding mileage to the extracted passenger and accumulates and manages the offered mileage in the customer information database (DB) 390 (S114).

By doing so, it is possible to maximize the satisfaction of airlines and customers and distribute demands concentrated on weekends, which are high-demand seasons, to off-seasons by offering mileage to the customers according to a load factor that can contribute to airlines' operating profits, i.e., by offering more mileage when the load factor is low and less mileage when the load factor is high.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

The present invention is not limited to the embodiments described above, and those skilled in the art can make various changes and modifications thereto, which fall within the spirit and scope of the present invention defined by the appended claims.

1. A discriminatory mileage offering method, comprising:
a first step of building a mileage database (DB) using mileage applied discriminatively according to a load factor;
a second step of receiving passenger boarding information from a terminal that makes communication connection over an information communication network, and storing and managing the boarding information in a customer information database (DB);
a third step of calculating a load factor based on the received boarding information, and retrieving mileage corresponding to the calculated load factor from the mileage database (DB); and
a fourth step of extracting a passenger to which the mileage retrieved through the third step is to be offered, offering the mileage to the extracted passenger, and storing and managing the offered mileage and information on the passenger in the customer information database (DB).

2. The method as claimed in claim 1, after the fourth step, further comprising a fifth step of supporting transmission of a text message indicating the retrieved mileage to a mobile communication terminal of the passenger.

3. The method as claimed in claim 1, wherein the mileage database (DB) stores the mileage therein such that the mileage is reduced as the load factor increases.

4. A computer readable record medium on which a program for discriminatively offering mileage by load factor is recorded, the program executing:
a first process of building a mileage database (DB) using mileage applied discriminatively according to a load factor;
a second process of receiving passenger boarding information from a terminal that makes communication connection over an information communication network, and storing and managing the boarding information in a customer information database (DB);
a third process of calculating a load factor based on the received boarding information, and retrieving mileage corresponding to the calculated load factor from the mileage database (DB); and
a fourth process of extracting a passenger to which the mileage retrieved through the third process is to be offered, offering the mileage to the extracted passenger, and storing and managing the offered mileage and information on the passenger in the customer information database (DB).

5. The record medium as claimed in claim 4, wherein after the fourth process, the program further executes a fifth process of supporting transmission of a text message indicating the retrieved mileage to a mobile communication terminal of the passenger.

6. The record medium as claimed in claim 4, wherein the mileage database (DB) stores the mileage therein such that the mileage is reduced as the load factor increases.
